(19) United States
(12) Patent Application Publication
(10) Pub. No.: US 2025/0204593 A1
(43) Pub. Date: Jun. 26, 2025

(54) VAPORIZER ALLOWING FOR TRANSVERSELY GUIDING LIQUID

(71) Applicant: HUIZHOU HAPPY VAPING TECHNOLOGY LIMITED, Huizhou, Guangdong (CN)

(72) Inventors: Guangrong Lin, Huizhou, Guangdong (CN); Xianbin Zheng, Huizhou, Guangdong (CN)

(21) Appl. No.: 18/848,935

(22) PCT Filed: Feb. 16, 2023
(86) PCT No.: PCT/CN2023/076501

§ 371 Date: Sep. 20, 2024

(30) Foreign Application Priority Data
Mar. 21, 2022 (CN) 202210281050.6

(51) Int. Cl. A24F 40/46; A24F 40/10; A24F 40/42; A24F 40/485; H05B 3/22

(52) U.S. Cl. CPC A24F 40/46; A24F 40/10; A24F 40/42; A24F 40/485; H05B 3/22

(57) ABSTRACT

A vaporizer allowing for transversely guiding liquid comprises a housing, in which a liquid storage chamber is defined. The housing is centrally provided with a flow path extending there-through, separated from the liquid storage chamber and having a vaporizing chamber, in which a vaporizing core is transversely disposed. The vaporizing core has a center through hole extending transversely with two ends being in communication with the liquid storage chamber, and comprises a porous body having a vaporizing surface, on which a heating layer is applied. Two distal ends of the heating layer are respectively connected with an electrode disk, and the heating layer is provided with vapor through-holes. Thus, the to-be-vaporized liquid is allowed to transversely flow into the center through hole, permeate to the vaporizing surface, be vaporized into vapor fog when the heating layer is electrified to generate heat, and flow out through the flow path.

### TECHNICAL FIELD

The disclosure relates to the technical field of the electronic cigarette vaporizers, and more particularly, the disclosure relates to a vaporizer allowing for transversely guiding liquid.

### BACKGROUND

For electronic vaporizing devices in the market, the basic task is to provide a vaporizing process for converting the to-be-vaporized liquid, for example, solutions such as e-cigarette liquid, stored in the electronic vaporizing device into vapor fog, aerosol fog, aerosol, steam, etc.

Usually, an electronic vaporizing device includes a battery part and a vaporizer part which are detachably connected. A battery cell, which is mounted inside the battery part, is to supply power to the vaporizer part. The vaporizer part includes a vaporizing core mounted on the vaporizing base. The vaporizing core can heat and atomize the to-be-vaporized solution, i.e., the to-be-vaporized liquid, into vapor fog or aerosol when powered on.

Some vaporizing cores of vaporizer parts in the market start to use the porous body as the liquid guiding material. As the to-be-vaporized liquid needs to flow onto an upper surface of the porous body from the liquid storage chamber and then permeate through the whole porous body from the upper surface to a lower surface to facilitate atomization, it achieves poor liquid guiding effect and is easy to cause insufficient atomization. Moreover, the vaporizer part of the electronic vaporizing device, which includes a vaporizer housing, a vaporizing cover part, a vaporizing core, a vaporizing base, a base, connecting electrodes, etc., has lots of accessories and thus a complicated structure. In addition, as the heating resistor of the vaporizing core needs to weld electrode leads during mounting of the vaporizing core into the vaporizer part, the perforation is required to facilitate the leading out of electrode leads to enable connection. Such sophisticated process makes it difficult to achieve automatic production.

### SUMMARY

### Technical Problems

The disclosure aims to provide a vaporizer allowing for transversely guiding liquid, to overcome the above shortcomings.

### Technical Solutions

A technical solution of the disclosure is provided as follows. It comprises a housing, a liquid storage chamber for storing the to-be-vaporized liquid is defined inside the housing in an upper portion of the housing, and a base and an electrode seat which are connected and arranged one above the other are connected within a bottom portion of the housing. The housing is centrally provided with a flow path communicating there-through from top to bottom and separated from the liquid storage chamber, the flow path comprises a vaporizing chamber, a vaporizing core is transversely disposed in the vaporizing chamber, the vaporizing core is provided with a center through hole extending transversely, two ends of the center through hole are in communication with the liquid storage chamber. The vaporizing core comprises a porous body, at least one surface of the porous body serves as a vaporizing surface, on which a heating layer is applied, two distal ends of the heating layer are respectively connected with an electrode disk, and the heating layer is provided with vapor through holes for allowing the to-be-vaporized liquid and vapor fog to flow out. The to-be-vaporized liquid is allowed to transversely flow into the center through hole, permeate to the vaporizing surface of the porous body, be vaporized into vapor fog when the heating layer is electrified to generate heat, and flow out through the flow path. The electrode seat is arranged with elastic electrodes abutting against the electrode disks and are connected thereto.

Preferably, an upper end surface of the base may be connected with a vaporizing core base, and a vapor channel extending there-through from top to bottom may be defined inside the vaporizing core base, the vapor channel may be one of sections of the flow path, the vaporizing chamber may be provided in the vapor channel, and two sides of the vaporizing core base may be respectively provided with a liquid inlet through hole for communicating the liquid storage chamber with the center through hole.

Preferably, supporting elements may be respectively inserted in the vaporizing core base on the two sides thereof, the liquid inlet through holes may be provided on the supporting elements, two ends of the vaporizing core may be connected with inner sides of the supporting elements, respectively, the vaporizing core base may be made of a hard material, the supporting elements may be made of a soft material, and the vaporizing core base and the supporting elements may be integrally formed.

Preferably, an annular shoulder extending radially inward may be provided on the upper end of an inner sidewall of the vapor channel, a lower portion of the annular shoulder may define an annular groove extending upward along the inner sidewall of the vapor channel, and the annular groove may serve to block and absorb condensed droplets carried by the vapor fog flowing upwards.

Preferably, outer surfaces of the porous body, except for the vaporizing surface, may be arranged with a coating layer, and the coating layer may consist of a dense ceramic layer, or a metal oxide coating layer, or a plastic layer, or a silicone layer.

Preferably, the vaporizing surface may be provided at a bottom surface and two opposite side surfaces of the porous body.

Preferably, the vaporizing surface may be designed as a curved surface with an arc shape.

Preferably, the vaporizing core may further comprise a base body, the center through hole may be provided in the base body, one of sides of the base body may be provided with a mounting groove along a direction of the center through hole, an inner space of the mounting groove may be in communication with the center through hole, an inner sidewall of the mounting groove may be embedded with the porous body, and a surface of the porous body facing outward may be provided as the vaporizing surface.

Preferably, the porous body may be composed of a porous ceramic body, or a microporous glass body, or a microporous metal body, the heating layer may consist of a porous metal sheet or a metal plating film, and the electrode disk may be composed of a metal sheet or a metal printing layer.

Preferably, the metal plating film may comprise a transition film and a heating film, both the transition film and the heating film may be provided with vapor through holes, and the vapor through holes may be micro through holes.

### Advantages

The vaporizer allowing for transversely guiding liquid comprises the liquid storage chamber and the vaporizing chamber. During assembly, the vaporizing core can be placed in the housing of the vaporize and transversely disposed in the vaporizing chamber, with two ends of the center through hole of the vaporizing core being directly communicated with the liquid storage chamber. In such a case, the to-be-vaporized liquid stored in the liquid storage chamber can smoothly flow into the center through hole, and the to-be-vaporized liquid inside the center through hole can be diffused and permeated around the porous body, thereby realizing quick and sufficient supply of the liquid to ensure sufficient vaporization. In addition, the vaporizer and the vaporizing core thereof according to the disclosure have simple structures. The electrode disks, which can be elastically connected to the spring electrodes, do not need to weld leads. They can be very conveniently mounted in the vaporizer, thereby facilitating automatic production of the vaporizer.

### BRIEF DESCRIPTION OF THE DRAWINGS

FIG. 1 is a perspective view of a vaporizer according to an embodiment of the disclosure;

FIG. 2 is an exploded perspective view of a vaporizer according to an embodiment of the disclosure;

FIG. 3 is a front, cross-sectional view of a vaporizer according to an embodiment of the disclosure;

FIG. 4 is a side, cross-sectional view of a vaporizer according to an embodiment of the disclosure;

FIG. 5 is a cross-sectional view of a vaporizing assembly of a vaporizer according to an embodiment of the disclosure;

FIG. 6 is an exploded perspective view which illustrates a structure of a vaporizing core base of a vaporizer according to an embodiment of the disclosure;

FIG. 7 is a cross-sectional view of a vaporizing core base of a vaporizer according to an embodiment of the disclosure;

FIG. 8 is a first perspective view of a vaporizing core of a vaporizer according to an embodiment of the disclosure;

FIG. 9 is a first exploded perspective view of a vaporizing core of a vaporizer according to an embodiment of the disclosure;

FIG. 10 is an exploded perspective view which illustrates a structure of a heating layer of a vaporizer according to an embodiment of the disclosure;

FIG. 11 is a second exploded perspective view of a vaporizing core of a vaporizer according to an embodiment of the disclosure;

FIG. 12 is a third exploded perspective view of a vaporizing core of a vaporizer according to an embodiment of the disclosure;

FIG. 13 is a fourth exploded perspective view of a vaporizing core of a vaporizer according to an embodiment of the disclosure;

FIG. 14 is a second perspective view of a vaporizing core of a vaporizer according to an embodiment of the disclosure;

FIG. 15 is a fifth exploded perspective view of a vaporizing core of a vaporizer according to an embodiment of the disclosure;

FIG. 16 is a perspective view of a porous body of a vaporizing core of a vaporizer according to an embodiment of the disclosure.

### PREFERRED EMBODIMENTS OF THE DISCLOSURE

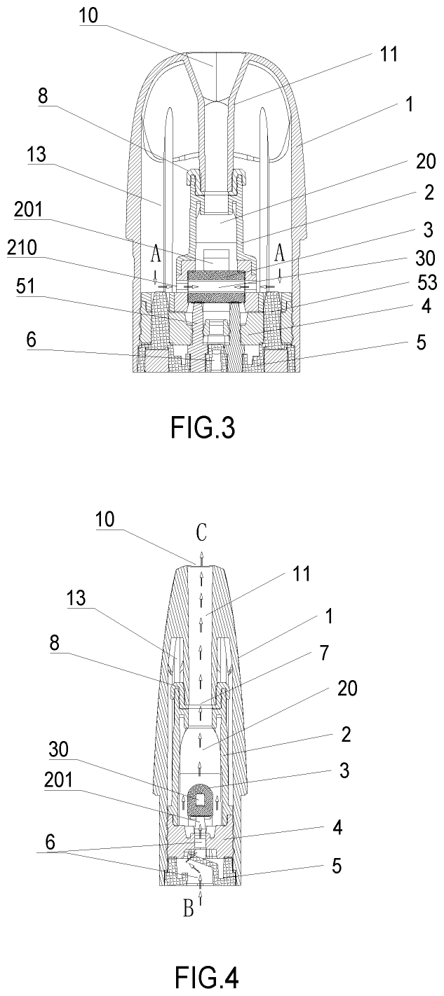

The vaporizer allowing for transversely guiding liquid of the disclosure can be connected with a battery part to constitute an electronic cigarette. For convenience of description, the mouthpiece 10 of the vaporizer allowing for transversely guiding liquid is vertically disposed to faces upwards, as shown in FIG. 3. The terms, such as “upper”, “lower”, “upper portion”, “lower portion”, “upper end”, “lower end”, “upper surface”, “lower surface”, “upwards”, “downwards” as used herein for illustrating the components, refer to position and orientation relationships when the mouthpiece is vertically disposed to face upwards.

### EMBODIMENTS OF THE DISCLOSURE

The disclosure will be further explained in detail with reference to particular embodiments in conjunction with the drawings.

### Embodiment 1

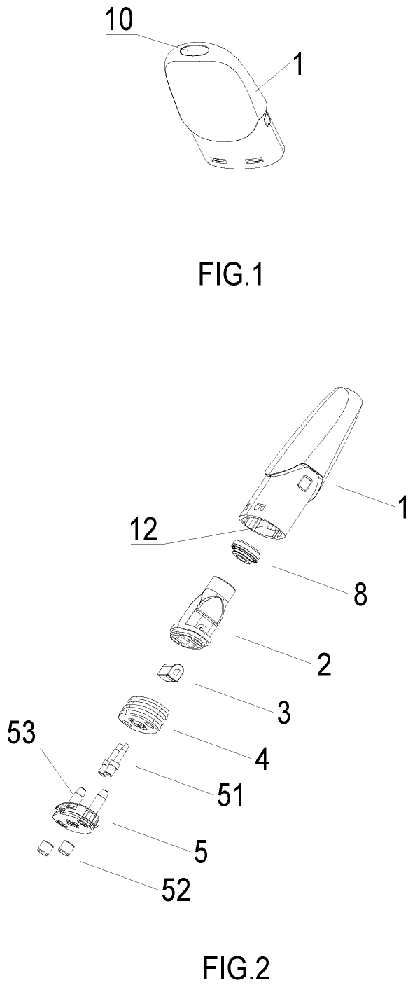

Referring to FIGS. 1-4, the vaporizer allowing for transversely guiding liquid in the embodiment is provided with a housing 1. A liquid storage chamber 13 is defined inside the housing 1 in an upper portion of the housing 1, and a base 4 and an electrode seat 5 which are connected and arranged one above the other are connected within a bottom portion of the housing 1. The flow path 7, which is centrally provided in the housing 1, extends through the housing 1 from top to bottom and is separated from the liquid storage chamber 13. The flow path 7 includes a vaporizing chamber 201, and a vaporizing core 3 is transversely disposed in the vaporizing chamber 201. The upper end surface of the base 4 is connected with a vaporizing core base 2, and a vapor channel 20 defined inside the vaporizing core base 2 extends through the vaporizing core base 2 from top to bottom. The vapor channel 20 is a section of the flow path 7, and the vaporizing chamber 201 is provided at the lower portion of the vapor channel 20. In particular, the housing 1 is provided at an upper end with a mouthpiece 10 and at a lower end with an opening 12. The mouthpiece 10 extends inward the housing and is formed with a vapor outlet tube 11. The base 4 and the electrode seat 5 are connected in the opening 12. The lower end of the vapor outlet tube 11 is connected with the vaporizing core base 2, and a sealing sleeve 8 is further arranged at the joint between the vapor outlet tube 11 and the vaporizing core base 2. The lower end of the vaporizing core base 2 is connected with the base 4. The liquid storage chamber 13 is defined by the space between the inner wall of the housing 1 and the vapor outlet tube 11, the vaporizing core base 2 and the base 4. The base 4 is made of soft materials such as silicone, to facilitate a sealing connection with the inner wall of the housing 1 and the bottom portion of the vaporizing core base 2 and avoid the leakage of the to-be-vaporized liquid stored in the liquid storage chamber 13. Two sides of the vaporizing core base 2 are respectively provided with a liquid inlet through hole 210 in communication with the liquid storage chamber 13. The vaporizing core base 2 is internally provided with the vapor channel 20 extending there-through from top to bottom. At the lower portion of the vapor channel 20, the vaporizing chamber 201 is provided, in which the vaporizing core 3 is transversely disposed. On each of the two sides of the vaporizing core 3, there is a gap to allow communication up and down through the vapor channel 20. The vaporizing core 3 is internally provided with a center through hole 30 extending transversely. Two ends of the center through hole 30 are respectively aligned and in communication with the two liquid inlet through holes 210. That is, the liquid inlet through holes 210 communicate the liquid storage chamber 13 with the center through hole 30.

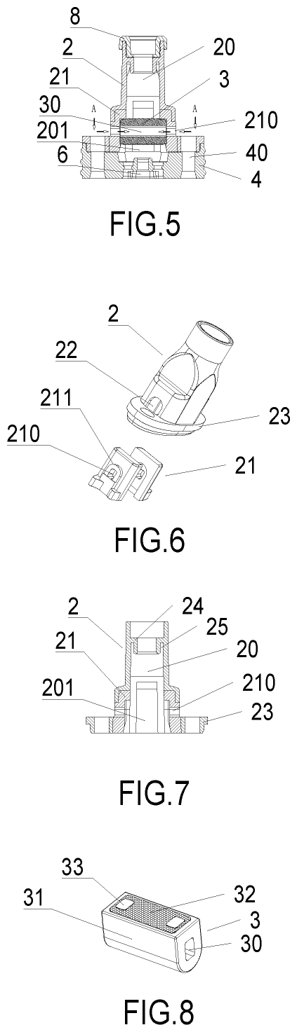

Referring to FIGS. 5, 6, and 7, wherein FIG. 5 illustrates the vaporizing assembly which is a structure assembled from the sealing sleeve 8, the vaporizing core base 2, the vaporizing core 3, and the base 4. The vaporizing core base 2 has a structure with a small upper portion and a large lower portion. The upper end of the vaporizing core base 2 is sleeved on the lower end of the vapor outlet tube 11. The middle portion of the vaporizing core base 2 has increased inner and outer diameters. Its bottom end is formed as a lid 23 which abuts against the base 4 and has an outer sidewall connected with the inner wall of the housing 1. In the bottom portion of the vaporizing core base 2, the supporting elements 21 are respectively inserted on two sides of the vaporizing chamber 201. The liquid inlet through holes 210 are provided on the supporting elements 21, and two ends of the vaporizing core 3 are connected with inner sides of the supporting elements 21, respectively. The vaporizing core base 2 is made of hard materials such as plastic, the supporting elements 21 are made of soft materials such as silicone, and the vaporizing core base 2 and the supporting elements 21 are integrally formed. Herein, the vaporizing core base 2 is provided at two sides with mounting holes 22. The outer sides of the supporting elements 21 are provided with protrusions 211, which are respectively exactly engaged in the mounting holes 22, at positions corresponding to the liquid inlet through holes 210. The supporting elements 21 functions to hold the vaporizing core 3 and facilitate the scaling between the vaporizing core base 2 and the end portions of the vaporizing core 3. It ensures the communication between the liquid storage chamber 13 and the center through holes 30, and meanwhile avoid the communication between the liquid storage chamber 13 and the vapor channel 20 to avoid leakage.

Referring to FIG. 7, the annular shoulder 24 is provided on the upper end of the inner sidewall of the vapor channel 20 and extends radially inward. The lower portion of the annular shoulder 24 defines an annular groove 25 extending upward along the inner sidewall of the vapor channel 20. The annular groove 25 serves to block and absorb condensed droplets carried by the vapor fog flowing upwards, and prevent the droplets that are not vaporized completely and contained in the vapor fog, and condensed droplets, from accessing user's mouth and resulting in poor user experience.

Referring to FIGS. 1-5, two clastic electrodes 51 are disposed on the electrode seat 5. The two elastic electrodes 51 abut against the electrode disks 33 of the vaporizing core and are connected thereto. The electrode seat 5 is further arranged with a magnetic body 52, to allow magnetic connection between the vaporizer and the battery part. The base 4 and the electrode seat 5 are respectively centrally provided with an air channel 6. The air channels 6 are in communication with each other and are in communication with the vaporizing chamber 201 located above. In addition, the base 4 is further provided with liquid filling through holes 40, and the electrode seat 5 is provided with plungers 53 for closing the liquid filling through holes 40 after the filling into the liquid storage chamber 13. According to the disclosure, the vaporizer and the vaporizing core thereof have simple structures. The electrode disks 33, which can be elastically connected to the spring electrodes 51, do not need to weld leads. They can be very conveniently mounted in the vaporizer, thereby facilitating automatic production of the vaporizer.

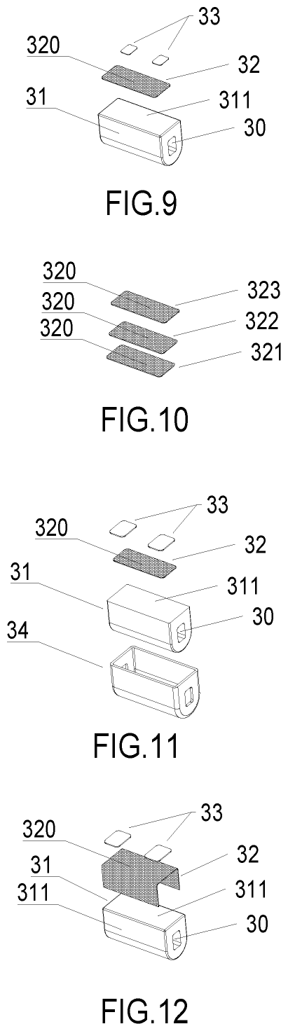

Referring to FIGS. 8 and 9, the vaporizing core 3 comprises a porous body 31. One surface of the porous body 31 serves as a vaporizing surface 311, on which the heating layer 32 is applied. Two distal ends of the heating layer 32 are respectively connected with an electrode disk 33. The heating layer 32 is provided with vapor through holes 320 which allow the to-be-vaporized liquid and the vapor fog to flow out. The to-be-vaporized liquid stored in the liquid storage chamber 13 may flow into the center through hole 30 transversely, and then permeate to the vaporizing surface 311. The heating layer 32 can heat and atomize the to-be-vaporized liquid into vapor fog when electrified. Then, the vapor fog may flow to the vaporizing chamber 201. In the embodiment, the vaporizing surface 311 of the vaporizing core 3 may be arranged on the bottom portion of the vaporizing core 3. The vapor fog produced when the heating layer 32 is heated may emit from the bottom portion of the vaporizing core 3 and then flow upwards through the gaps on the two sides of the vaporizing core 3.

Referring to FIG. 3, the series of arrows started from point A illustrate a direction in which the to-be-vaporized liquid flows. That is, when the vaporizer operates, the to-be-vaporized liquid flows through the liquid inlet through holes 210 from the liquid storage chamber 13 into the center through hole 30. The vaporizing core 3 of the disclosure is placed inside the housing of the vaporizer and is transversely disposed in the vaporizing chamber 201. Two ends of the center through hole 30 of the vaporizing core are directly communicated with the liquid storage chamber 13. In such a case, the to-be-vaporized liquid stored in the liquid storage chamber 13 can smoothly flow into the center through hole 30, and the to-be-vaporized liquid inside the center through hole 30 can be diffused and permeated around the porous body 31, thereby realizing quick and sufficient supply of the liquid to ensure sufficient vaporization, and providing good user experience.

Referring to FIG. 4, the series of arrows from point B to point C illustrate a direction in which the air flows. That is, when the vaporizer operates, outside air may flow into the vaporizing chamber 201 through the air channels 6 of the base 4 and the electrode seat 5. The to-be-vaporized liquid may be heated and vaporized on the vaporizing surface 311 of the porous body, such that vapor fog may be produced in the vaporizing chamber 201 and then flow upwards along with the entered air, flow through the vapor channel 20, the vapor outlet tube 11, and the mouthpiece 10, and then can be vaped by the user. The air channels 6, the vaporizing chamber 201, the vapor channel 20, the vapor outlet tube 11, and the mouthpiece 10 as mentioned above collectively constitute the flow path 7.

In the embodiment, the porous body 31 may be a porous ceramic body, and the heating layer 32 may be a metal plating film consisting of metal nano plating film. The vapor through holes 320 provided on the metal plating film may be numerous, uniformly distributed, and micron-sized micro through holes 320, which allow the to-be-vaporized liquid contained in the porous body 31 to permeate through the metal plating film to allow vaporization. The electrode disk 33 may be composed of a printing layer of metal silver which has excellent electrical conductivity, good contact, resistance to decomposition, and high stability. The heating layer 32 of the disclosure may be a metal plating film having a large heating area and meanwhile allowing the vapor fog to be released from the micro through holes without hindrance. Thus, the vaporization amount of the to-be-vaporized liquid can be greatly improved. During heating, the entire surface of the metal plating film may be heated evenly, thereby reducing carbon deposit and leakage. Without imbalanced thermal stress during high-temperature operation, the metal plating film does not have a risk of breakage, thereby enhancing product consistency and providing users with a superior experience.

Referring to FIG. 10, the metal plating film of the heating layer 32 in the embodiment may comprise a transition film 321 and a heating film 322, and a protection film 323 may be further arranged on the outer side of the metal plating film. The transition film 321 may be adhered to the heating film 322 and the protection film 323. The transition film 321, the heating film 322, and the protection film 323 may be all provided with micro through holes to allow permeation and thus vaporization of the to-be-vaporized liquid. The transition film 321 may be made of metal titanium and primarily not serve to perform heating, and the heating film 322 may be made of metal platinum and mainly serve to perform heating. The heating film 322 may use metal platinum, due to its low resistance and, more importantly, its chemical inertness. It can effectively prevent the interdiffusion between the film and the ceramic substrate at high operating temperatures, which could lead to an increase in resistance and affect the operation consistency of the vaporizing core. The titanium layer of the transition film 321 not only may enhance the adhesion between the metal platinum Pt and the substrate, but also may prevent the metal platinum from reacting, at high temperatures during operation of the vaporizer, with silicon materials contained in the ceramic matrix to form silicide.

In the present embodiment, the protection film 323 may be composed of silicon nitride material. The protective film 323 may serve to protect the heating film 322, preventing it from oxidation and corrosion, and further serve to provide insulation.

### Embodiment 2

Referring to FIG. 11, in addition to the structural features described in the embodiment 1, outer surfaces of the porous body 31, except for the vaporizing surface 311, may be further arranged with a coating layer 34 in the present embodiment. Since negative pressure may be generated in the vapor channel during operation of the vaporizer device, the to-be-vaporized liquid may be prone to leakage from the non-vaporizing surface of the porous body 31, resulting in access of droplets that are not vaporized into user's mouth and thus poor user experience. The coating layer 34, which is made of dense and impermeable material, may encapsulate the non-vaporizing surface of the porous body 31, thereby preventing leakage of the to-be-vaporized liquid from the porous body 31 and thus improving the aforementioned deficiencies. In the present embodiment, the coating layer 34 may consist of a dense ceramic layer, and the porous body 31 may be composed of a porous ceramic body. They both may be made of different ceramic matrix materials, integrally formed, and produced by sintering.

In other embodiments, the coating layer 34 may consist of a metal oxide coating layer, a plastic layer, or a silicone layer.

### Embodiment 3

Referring to FIG. 12, in addition to the structural features described in the embodiment 1, the vaporizing surface 311 in the present embodiment may be provided at the bottom surface and two opposite side surfaces of the porous body 31. That is, three surfaces, including the bottom surface and two side surfaces of the vaporizing core 3, may be used for heating and vaporizing. In such a case, the vaporizing surface area and thus the vaporizing amount can be increased, thereby providing users with better vaporizing and vaping experience.

### Embodiment 4

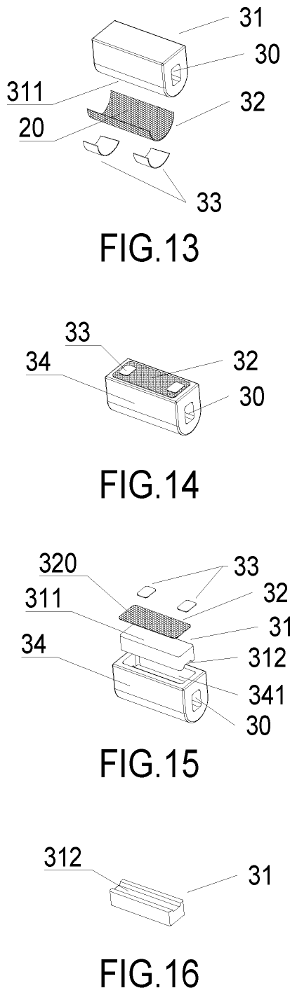

Referring to FIG. 13, in addition to the structure described in the embodiment 1, the vaporizing surface 311 provided at the bottom portion of the vaporizing core in the present embodiment may be designed as a curved surface with an arc shape. The heating film 32 may be attached onto the vaporizing surface 311 by curved surface coating, and the electrode disk 33 may be constructed in the form of a printing layer of metal silver. As the vaporizing surface 311 is designed as a curved surface with an arc shape, the vaporizing surface area can be increased within the same space, thereby increasing the vaporization amount and providing users with better vaping experience.

### Embodiment 5

Referring to FIGS. 14, 15, and 16, in addition to the structure described in the embodiment 1, the vaporizing core 3 in the present embodiment may further comprise a base body 34, the center through hole 30 may be transversely centrally provided in the base body 34, one of the sides of the base body 34 may be provided with a mounting groove 341 along the direction of the center through hole 30, and the inner space of the mounting groove 341 may be in communication with the center through hole 30. The inner sidewall of the mounting groove 341 may be embedded with the porous body 31 which is heat-resistant and permeable to the to-be-vaporized liquid. The vaporizing surface 311 may be provided at the surface of the porous body 31 facing outward, the heating layer 32 generates heating when electrified, and two distal ends of the heating layer 32 may be connected with the electrode disks 33, respectively. The electrode disk 33 is applied onto the surface of the heating layer 32, to connect the electrodes for supplying power. The side of the porous body 31 facing the center through hole 30 may be longitudinally provided with a liquid guiding groove 312, along the center through hole 30. Due to the liquid guiding groove 312, the thickness of the porous body 31 from the side having the liquid guiding groove to the vaporizing surface 311 can be reduced, thereby facilitating quick permeation of the to-be-vaporized liquid to the vaporizing surface 311. Through two ends of the center through hole 30, the to-be-vaporized liquid may be guided into the porous body 31, and then the to-be-vaporized liquid may be permeated from the porous body 31 to the vaporizing surface 311, and heated and vaporized into vapor fog by the heating layer 32.

According to the present embodiment of the disclosure, the base body 34 may be composed of a dense ceramic body, and the porous body 31 may be composed of a porous ceramic body. They both may be made of different ceramic matrix materials, integrally formed, and produced by sintering. The heating layer 32 may be composed of a metal plating film. The metal plating film may be provided with vapor through holes 320 which allow the to-be-vaporized liquid and the vapor fog to pass through. The metal plating film can heat and atomize the to-be-vaporized liquid on the vaporizing surface 311 into vapor fog when electrified, and allow the vapor fog to flow out through the vapor through holes 320. As the vaporizing core in the present embodiment is provided with the base body 34, the vaporizing core 3 has better sealing, insulation, and heat insulation performances.

In other embodiments, the base body 34 may be made of hard plastic materials, the porous body 31 may be composed of a microporous glass body or a microporous metal body, the heating layer 32 may be made of heating resistance wire or a porous metal sheet, the electrode disk 33 may be composed of a metal sheet or a metal plating film, and the electrode disk 33 may be connected with electrode leads. An insulation layer may be further provided between the porous body 31 and the heating layer 32. In other embodiments, the vaporizing surface 311 of the vaporizing core 3 may be provided at the upper portion of the vaporizing core 3.

### INDUSTRIAL APPLICABILITY

All the above are merely preferred embodiments of the disclosure. The present invention is intended to cover all equivalent arrangements and modifications derived from the claims of the present invention.

1. A vaporizer allowing for transversely guiding liquid, characterized by comprising a housing, a liquid storage chamber for storing to-be-vaporized liquid is defined inside the housing in an upper portion of the housing, a base and an electrode seat which are connected and arranged one above the other are connected within a bottom portion of the housing, the housing is centrally provided with a flow path extending there-through from top to bottom and separated from the liquid storage chamber, the flow path comprises a vaporizing chamber, a vaporizing core is transversely disposed in the vaporizing chamber, the vaporizing core is provided with a center through hole extending transversely, two ends of the center through hole are in communication with the liquid storage chamber, the vaporizing core comprises a porous body, at least one surface of the porous body serves as a vaporizing surface, on which a heating layer is applied, two distal ends of the heating layer are respectively connected with an electrode disk, the heating layer is provided with vapor through holes for allowing the to-be-vaporized liquid and vapor fog to flow out; the to-be-vaporized liquid is allowed to transversely flow into the center through hole, permeate to the vaporizing surface of the porous body, be vaporized into vapor fog when the heating layer is electrified to generate heat, and flow out through the flow path; the electrode seat is arranged with elastic electrodes abutting against the electrode disks and are connected thereto.

2. The vaporizer allowing for transversely guiding liquid according to claim 1, wherein an upper end surface of the base is connected with a vaporizing core base, and a vapor channel extending there-through from top to bottom is defined inside the vaporizing core base, the vapor channel is one of sections of the flow path, the vaporizing chamber is provided in the vapor channel, and two sides of the vaporizing core base are respectively provided with a liquid inlet through hole for communicating the liquid storage chamber with the center through hole.

3. The vaporizer allowing for transversely guiding liquid according to claim 2, wherein supporting elements are respectively inserted on two sides in the vaporizing core base, the liquid inlet through holes are provided on the supporting elements, two ends of the vaporizing core are connected with inner sides of the supporting elements, respectively; and the vaporizing core base is made of a hard material, the supporting elements are made of a soft material, and the vaporizing core base and the supporting elements are integrally formed.

4. The vaporizer allowing for transversely guiding liquid according to claim 2, wherein an annular shoulder extending radially inward is provided on an upper end of an inner sidewall of the vapor channel, a lower portion of the annular shoulder defines an annular groove extending upward along an inner sidewall of the vapor channel, and the annular groove serves to block and absorb condensed droplets carried by the vapor fog flowing upwards.

5. The vaporizer allowing for transversely guiding liquid according to claim 1, wherein outer surfaces of the porous body, except for the vaporizing surface, are further arranged with a coating layer, and the coating layer consists of a dense ceramic layer, or a metal oxide coating layer, or a plastic layer, or a silicone layer.

6. The vaporizer allowing for transversely guiding liquid according to claim 1, wherein the vaporizing surface is provided at a bottom surface and two opposite side surfaces of the porous body.

7. The vaporizer allowing for transversely guiding liquid according to claim 1, wherein the vaporizing surface is designed as a curved surface with an arc shape.

8. The vaporizer allowing for transversely guiding liquid according to claim 1, wherein the vaporizing core further comprises a base body, the center through hole is provided in the base body, one of sides of the base body is provided with a mounting groove along a direction of the center through hole, an inner space of the mounting groove is in communication with the center through hole, an inner sidewall of the mounting groove is embedded with the porous body, and a surface of the porous body facing outward is provided as the vaporizing surface.

9. The vaporizer allowing for transversely guiding liquid according to claim 1, wherein the porous body is composed of a porous ceramic body, or a microporous glass body, or a microporous metal body, the heating layer consists of a porous metal sheet or a metal plating film, and the electrode disk is composed of a metal sheet, or a metal printing layer.

10. The vaporizer allowing for transversely guiding liquid according to claim 9, wherein the metal plating film comprises a transition film and a heating film, both the transition film and the heating film are provided with vapor through holes, and the vapor through holes are micro through holes.
